(19) United States
(12) Patent Application Publication
(10) Pub. No.: US 2013/0281023 A1
(43) Pub. Date: Oct. 24, 2013

(54) ENABLING FEATURES AND DISPLAY REMINDERS ON A MOBILE PHONE

(71) Applicants: Vishnu Madanarajagopal, Canton, MI (US); Steven P. Schwinke, Plymouth, MI (US); Jeffrey G. Ravas, Oxford, MI (US); Steven J. Ross, Livonia, MI (US)

(72) Inventors: Vishnu Madanarajagopal, Canton, MI (US); Steven P. Schwinke, Plymouth, MI (US); Jeffrey G. Ravas, Oxford, MI (US); Steven J. Ross, Livonia, MI (US)

(73) Assignee: GENERAL MOTORS LLC, Detroit, MI (US)

(21) Appl. No.: 13/452,320

(22) Filed: Apr. 20, 2012

(51) Int. Cl. H04B 7/00

(52) U.S. Cl. 455/41.3

(57) ABSTRACT

A method and system of providing a reminder message to a vehicle user, comprising the steps of establishing a short-range wireless communication between a vehicle and a mobile phone or other handheld communications device carried by the user; determining a vehicle trip initiation or termination involving the vehicle user; and providing a reminder message to the vehicle user via the handheld communications device in response to that determination. In addition, the method may comprise the step of transmitting an instruction from the handheld communications device comprising the execution of an auxiliary vehicle function.

### TECHNICAL FIELD

The present invention relates generally to short-range wireless communications and more particularly to short-range wireless communications between vehicles and handheld communications devices.

### BACKGROUND OF THE INVENTION

Vehicles may include telematics systems that monitor information describing the vehicle's location and diagnostic conditions. Such telematics systems may comprise an embedded cellular telephone which is capable of cellular telephony. The telematics device may have the capability of communicating using short-range wireless communication such as Bluetooth™.

Modern cellular telephones comprise features and software applications beyond mere telephony. Such cellular phones (e.g., Smart phones) may also communicate using Bluetooth™.

### SUMMARY OF THE INVENTION

According to an aspect of the invention, there is provided a method of providing a reminder message to a vehicle user, comprising the steps of: establishing a short-range wireless communication between a vehicle and a handheld communications device (HCD) carried by a vehicle user; determining a vehicle trip initiation or termination based on one or more detected vehicle trip endpoint indicators involving the user; and providing a reminder message to the vehicle user via the HCD in response to said determination.

According to another aspect of the invention, there is provided a system of a reminder message to a vehicle user, comprising: a computer program product stored on a computer readable medium for a handheld communications device (HCD) having directional motion detection hardware, comprising one or more software programs that include program instructions that upon execution by the HCD cause it to recognize one or more directional motions associated with a vehicle ingress or a vehicle egress of a vehicle user carrying the HCD; and a vehicle telematics device (VTD) in short-range wireless communication with the HCD, wherein the vehicle user is provided a reminder message when the directional motion detection hardware and computer program product of the HCD detect one or more directional motions associated with the vehicle ingress or the vehicle egress of the vehicle user within a selected amount of time.

### BRIEF DESCRIPTION OF THE DRAWINGS

One or more preferred exemplary embodiments of the invention will hereinafter be described in conjunction with the appended drawings, wherein like designations denote like elements, and wherein:

FIG. 1 is a block diagram depicting an exemplary embodiment of a communications system that is capable of utilizing the method disclosed herein; and

FIG. 2 is a flowchart depicting a method of providing a reminder message to a vehicle user.

FIG. 3 shows a handheld communications device oriented within the x, y, and z axes of a Cartesian coordinate system.

### DETAILED DESCRIPTION OF THE ILLUSTRATED EMBODIMENT(S)

### Communications System—

Modern vehicles may be equipped with modular or embedded wireless telephony and may also be enabled with short-range wireless communication capability such as WiFi or Bluetooth™. They may also comprise a variety of sensors which can detect vehicle location, whether the vehicle door is ajar or locked, whether the vehicle needs maintenance, etc. In addition to wireless telephony capability, modern handheld communication devices (HCDs), such as mobile phones and smart phones, may wirelessly communicate via short-range wireless communication. Using established communication protocols, the vehicle and the HCD may identify each other and establish short-range wireless communication, e.g., where the owner owns both the vehicle and the HCD. Using short-range wireless communication and one or more vehicle trip endpoint (VTE) indicators, it may be determined whether the vehicle user with his or her HCD is in the process of beginning or ending a vehicle trip (i.e., use of the vehicle to drive somewhere). Based on this, a reminder message may be presented to the user, such as a reminder to lock the vehicle following termination of a vehicle trip. Any one or more of a wide variety of different VTE indicators may be used, including ones indicative of starting or stopping vehicle use, ingress or egress into/out of the vehicle by the user and HCD, etc. Optionally, the person carrying the HCD may remotely send the vehicle an instruction commanding the vehicle to perform some vehicle function, such as locking the vehicle doors.

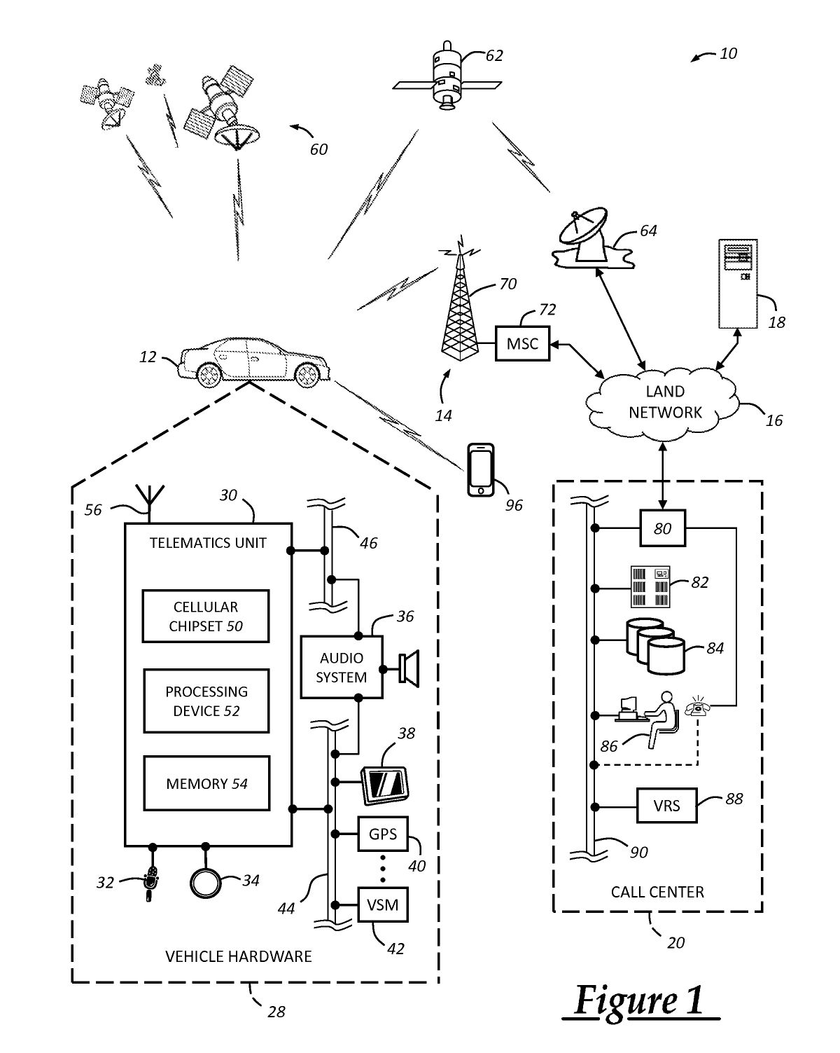

With reference to FIG. 1, there is shown an exemplary operating environment that comprises a mobile vehicle communications system 10 and that can be used to implement the method disclosed herein. Communications system 10 generally includes a vehicle 12, one or more wireless carrier systems 14, a land communications network 16, a computer 18, a call center 20, and a handheld communications device 96. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such exemplary system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that enables wireless voice and/or data communication over wireless carrier system 14 and via wireless networking so that the vehicle can communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols (e.g., WiFi, WiFi Direct, etc.), WiMAX, or Bluetooth™. When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30. Using GPS coordinate information the vehicle 12 may have location awareness which may include identifying the name of a residential or commercial entity at a given location or address and/or the category or type of entity at a given location or address. This information may be stored in the digital memory devices 54 of the vehicle telematics unit 30. In some implementations, location awareness may only be utilized when the vehicle 12 remains stationary at the given location or address for a selected amount of time which may be predetermined. For example, when the vehicle stops at a grocery store for the selected amount of time (e.g., more than ten minutes), the vehicle telematics unit 30 may store in its digital memory device 54 the name, address, and category of the entity; e.g., ‘Farmer's Market,’ 123 Example Street, grocery store. In another implementation, location awareness may be ‘learned.’ For example, where the name, address, and category of the entity is known, the user may elect to store the location in the digital memory device 54 of the vehicle telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module (BCM) that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

According to one embodiment, the BCM and/or other VSMs 42 may provide one or more of the vehicle trip endpoint (VTE) indicators, such as by real-time data from: sensors that may detect whether a door of the vehicle 12 is unlocked and/or partially or fully open or closed; sensors that may detect whether a window of the vehicle 12 is partially or fully open or closed; sensors that may detect whether any lighting of vehicle 12 is ON or OFF; sensors that may detect and/or diagnose necessary or scheduled maintenance of the vehicle 12 [for example whether: a battery needs of electrical charge, a fluid needs changing or filling (such as gasoline, oil, coolant, transmission fluid, brake fluid, air within the tires, windshield washer fluid, etc.), an air filter needs replacing, or a particular service is needed (such as engine service, transmission service, brakes service, etc.), and/or gas economy is adequate or normal]; sensors that may detect whether a person is seated in the vehicle 12 (e.g., in a driver's seat or passenger's seat); sensors that may detect whether a person is sitting down or rising from the seat of the vehicle 12 (e.g., the seat of the driver or passenger). In one embodiment, a threshold seat pressure may be predetermined based upon the weight applied by human factors engineering (human factors engineering is an applied science that coordinates the design of devices, systems, and physical conditions with the capacities and requirements of a person). A threshold hold may mean a value or a level, in this case determined to equate to the minimum pressure applied to the seat of the vehicle 12 by a 0-100^{th} percentile human being. In one implementation when a person may sit down, the change in the seat pressure may be an increase from below the threshold seat pressure to above the threshold seat pressure. Similarly, when a person may rise from sitting in the seat of the vehicle 12, the change in the seat pressure may be a decrease from above the threshold seat pressure to below the threshold seat pressure. Other real-time data provided by the BCM may include: sensors that may detect the insertion/removal of an ignition key of the vehicle 12 into/from an ignition lock of vehicle 12; sensors that may detect engagement/disengagement of an engine of the vehicle 12; e.g., by starting or turning off the engine by turning the ignition key or pushing a button that is to start or stop the engine; sensors that may detect engagement or disengagement of a transmission of the vehicle 12 including placing the vehicle 12 in PARK or placing the vehicle 12 in DRIVE or REVERSE; sensors that may detect depression of an acceleration pedal, a brake pedal and/or a clutch pedal of the vehicle 12; and sensors that may detect an engagement or disengagement of a seat buckle or passenger restraint of the vehicle 12.

According to another implementation, the BCM may control the execution of one or more auxiliary vehicle functions. Auxiliary vehicle functions may comprise electro-mechanical operations including: locking and/or unlocking the doors of the vehicle 12; at least partially closing and/or opening of the windows of the vehicle 12; and turning on and/or off the lighting of the vehicle 12 (e.g., a plurality of running lights, interior lights, headlights, etc).

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

As indicated in FIG. 1, short-range wireless communication may be used for exchanging data over short distances from fixed and mobile devices (and may use short wavelength radio transmissions). Examples of peer-to-peer (P2P) short-range wireless communications include Bluetooth™ and WiFi Direct. Other short-range wireless communication approaches may be used. Non limiting examples of which include using an IEEE 802.11a standard, an IEEE 802.11b standard, an IEEE 802.11g standard, an IEEE 802.11n standard, other WiFi standards ZigBee™, wireless infrared transmission, or combinations thereof.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

The handheld communication device 96 may be an electronic device which may be used to make mobile telephone calls across a wide geographic area where transmissions are facilitated by the wireless communication system 16 (also shown in FIG. 1). The HCD may include: hardware, software, and/or firmware enabling cellular telecommunications and communications via short-range wireless communication (e.g., WiFi Direct and Bluetooth™) as well as other HCD applications. Such HCD applications may include software applications, which may be preinstalled or installed by the user and/or via a graphical user interface (GUI) to control the hardware device using firmware and/or software. The hardware of the HCD 96 may comprise: a display, a keypad (e.g., push button and/or touch screen), a microphone, one or more speakers, motion-detection sensors (such as accelerometers, gyroscopes, etc.), and a camera. In addition to the aforementioned features, modern HCDs may support additional services and/or functionality such as short messaging service (SMS or texts), multimedia messaging service (MMS), email, internet access, short-range wireless communications (e.g., Bluetooth™ or WiFi Direct), as well as business and gaming applications. Non-limiting examples of the HCD 96 include a cellular telephone, a personal digital assistant (PDA), a Smart Phone, a personal laptop computer having two-way communication capabilities, a netbook computer, or combinations thereof. The HCD 96 may be used inside or outside of a mobile vehicle (such as the vehicle 12 shown in FIG. 1), and may be configured to provide services according to a subscription agreement with a third-party facility.

The HCD 96 and the vehicle 12 may be used together by a person known as the vehicle user. The vehicle user does not need to be the driver of the vehicle 12 nor does the vehicle user need to have ownership of the HCD 96 or the vehicle 12 (e.g., the vehicle user may be an owner or a licensee of either or both).

### Method—

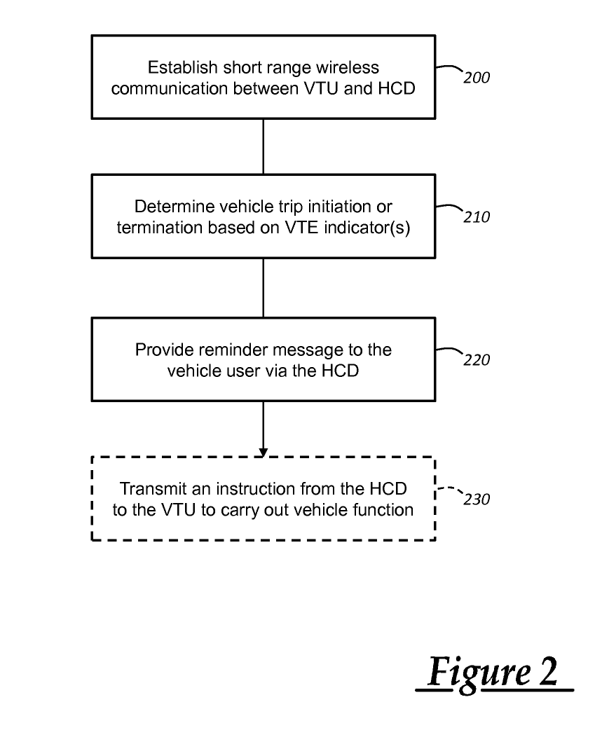

Now turning to FIG. 2 which shows a method of providing a reminder message to a vehicle user of the vehicle 12 and the HCD 96. A reminder message may be any message which may refresh the vehicle user's memory or prompt the vehicle user to remember something. FIG. 2 shows the following steps which may be used to provide the reminder message to the user: establishing short-range wireless communication between the vehicle telematics unit 30 and a hand-held communications device (HCD 96) carried by the vehicle user (200); determining a vehicle trip initiation or termination based on one or more detected trip endpoint indicators involving the user (210); providing a reminder message to the vehicle user via the HCD when the vehicle trip initiation or termination is determined (220); and optionally transmitting an instruction from the HCD 96 to the vehicle telematics unit 30 comprising the execution of an auxiliary vehicle function 230.

The establishing step 200 may be accomplished by any short-range wireless communication wherein exemplary embodiments include Bluetooth™ and WiFi Direct. Bluetooth™ is a master-slave protocol wherein devices can switch roles by agreement (i.e., the slave may become the master). In one embodiment, the vehicle may be the master and the HCD 96 may be the slave. Bluetooth™ protocols may require pairing or bonding. During operation, Bluetooth™ devices may be in various discoverability modes; e.g., a non-discoverable mode, a limited discoverable mode, or a general discoverable mode. In the non-discoverable mode, the device may not respond to inquiries. In the limited discoverable mode, the device may respond to specific events and/or at certain times. And in the general discoverable mode, the device may respond to general inquiries. In the limited or general discoverable modes, the Bluetooth™ device may transmit the following information on demand: the device name; the device class; a list of services; and certain technical information (e.g., the device features, the manufacturer, the Bluetooth™ specification that it uses, and clock offset). When the Bluetooth™ device is in the limited or general discoverable mode, the pairing process may automatically occur the first time the device receives a connection request from a device with which it is not yet paired. Once pairing is established, the pairing may be remembered by both devices due to the creation of a shared secret known as a link key. Once paired, the devices are bonded. When two bonded devices come in the vicinity of one other and one bonded device wishes to communicate with the other, it can cryptographically authenticate the identity of the other. In some examples, pairing mechanisms may prompt the user (e.g., the person carrying the HCD 96) to confirm the pairing process. Examples of pairing mechanisms may include: Bluetooth™ legacy pairing; Secure Simple Pairing (SSP) such as Passkey Entry and Out of Band (OOB). Once paired or bonded, Bluetooth™ devices may use a communication protocol known as OBEX (a.k.a. OBject EXchange) which facilitates the exchange of binary objects between devices and allows the transfer of files, appointments, reminders, etc.

Another exemplary embodiment of the short-range wireless communication may be WiFi Direct. WiFi Direct also requires configuration to set up shared resources and to transmit files. WiFi Direct may use the same frequencies as Bluetooth™, but may also use higher power. Unlike traditional WiFi, WiFi Direct may allow devices to communicate with each other in a P2P configuration without using wireless access points (WAP or hotspots). WiFi Direct functions in part by embedding a software access point (soft AP) into the new wireless device that it wishes to support. WiFi Direct may use WiFi Protected Setup (WPS) which may simplify the process of configuring security in short-range wireless communication. For example, two wireless devices may communicate by initially connecting using an ad hoc protocol to create a P2P communication. Once P2P communication is established, the wireless device may gather set up information using a protected set up style transfer. It may then disconnect and then reconnect using WiFi Direct.

After the short-range wireless communication is established (200) or as a part of the process of detecting and establishing the communication, step 210 is carried out which involves determining the existence of the a vehicle trip initiation or determination. That is, is the user in the process of beginning or finishing a drive in the vehicle. This determination need not conclusively determine that such a trip initiation or termination is occurring, but may rely on events commonly associated with or indicative of the initiation or termination of a vehicle trip. This may be done using one or more vehicle trip endpoint (VTE) indicators which may include, for example, determining whether the vehicle user carrying the HCD 96 ingressed the vehicle or egressed the vehicle, detecting an event associated with a trip endpoint (such as an ignition on or ignition off event), etc.

The VTE indicators relevant to ingress or egress may be derived from a predetermined list. Non-limiting examples of VTE indicators include: detecting a wireless signal strength that traverses a first threshold; detecting a wireless signal strength that traverses a second threshold which is less than the first threshold; detecting a sensor input of the vehicle 12 associated with the vehicle ingress or the vehicle egress of the vehicle user carrying the HCD; detecting at least one directional motion at the HCD associated with the vehicle ingress or the vehicle egress of the vehicle user carrying the HCD; location awareness using local WiFi or WLAN; location awareness using GPS coordinates; and determining the detection of one VTE indicator within a selected amount of time before or after that of another VTE indicator. It should be appreciated that when comparing the occurrence of two VTE indicators, the VTE indicators may be of the same type; e.g., two sensor inputs associated with vehicle ingress or vehicle egress or two directional motions at the HCD.

As enumerated above, one VTE indicator may be detecting a wireless signal strength that traverses a first threshold. Wireless signal strength may be directly related to the distance a receiving device is from the source of a transmission. For example, Bluetooth™ transmission may be classified in three different categories: class 1 may be for wireless signal strength which can extend to approximately 100 meters; class 2 may be for wireless signal strength that can extend to approximately 10 meters and class 3 may be for wireless signal strength that extends to approximately one meter. WiFi Direct transmission power is similar to Bluetooth™; however, the signal strength is typically greater therefore the wireless signal strength can be detected at greater ranges. The wireless signal strength detected by a receiving device is subject to the inverse square rule; i.e., the energy of the wireless signal strength diminishes inversely as a square of the distance from a transmitting device. To illustrate, if the receiving device (e.g., the HCD 96) is ‘S’ distance from the transmitting source (e.g., the vehicle 12), then for any distance S, the signal strength decreases by 1/S². The values of maximum signal strength and minimum signal strength may vary depending on systems characteristics such as power of the transmitter, hardware implementation, filtering design at the receiver, the medium of transmission, the path of transmission (e.g., where the path is uninhibited or comprised of obstacles), and any noise internal to the devices or environmental noise (i.e., noise within the medium of transmission). Bluetooth™ and WiFi Direct compatible devices permit both receiving and transmitting within short-range wireless communications. Bluetooth™ and WiFi Direct are merely exemplary; other types of short-range wireless communication may have threshold signal strengths of varying magnitudes. Traversing may be given its common, ordinary meaning; therefore, to traverse may mean to cross or go across something. Thus in the context of wireless signal strength, to traverse the first threshold means to cross some level or value of the wireless signal strength. In one implementation, the two devices using short-range wireless communication are the HCD 96 and the vehicle telematics unit 30. The first threshold may be predetermined based upon system characteristics and may be a maximum or near maximum wireless signal strength value associated with the HCD 96 being in close vicinity to the vehicle 12 where the wireless signal strength may be the strongest (e.g., it may be a value associated with the wireless signal strength within the interior of the vehicle). The first threshold may be ‘learned’ by the HCD 96. This learning process may be accomplished by: placing the HCD 96 within the interior of the vehicle; detecting the first threshold of the wireless signal strength; providing input to the GUI or software program or application of the HCD 96 (e.g., an acknowledgement that the HCD 96 is within the interior of the vehicle 12); and storing the value of the first threshold in the memory of the HCD 96. In one embodiment, the first threshold is a value associated with the strongest signal strength detectable by the HCD 96. Traversing the first threshold from LOW to HIGH (i.e., rising above the threshold) may indicate ingress of the vehicle, whereas traversing the first threshold from HIGH to LOW (i.e., falling below the threshold) may indicate egress from the vehicle.

Another VTE indicator may be detecting a wireless signal strength that traverses a second threshold which is less than the first threshold. The value of the second threshold may be predetermined based upon the system's characteristics; and in one implementation, the short-range wireless communication devices may be the HCD 96 and the vehicle telematics unit 30. The second threshold may be a minimum or near minimum wireless signal strength value associated with the HCD 96 being in the vicinity of the vehicle 12. The strongest wireless signal strength detectable by the HCD 96 may be within the vehicle 12. Similarly, the weakest wireless signal strength detectable by the HCD 96 is likely to be outside of the vehicle 12. Since the wireless signal strength will decrease exponentially with distance from the source (due to the inverse square rule), there is a range at which the wireless signal strength becomes undetectable due to the aforementioned system characteristics (e.g., the wireless signal is no longer distinguishable from the environmental noise). At some distance inside this range, the wireless signal strength is weak but detectable. The second threshold may be any value between (and including) this weak but detectable wireless signal strength and the value of the first threshold. In one embodiment, the second threshold may also be ‘learned’ by: placing the HCD 96 exterior of the vehicle at a distance from the vehicle 12 where the wireless signal strength is weak but detectable; detecting a wireless signal strength that is less than the first threshold; providing input to the GUI or software program or application of the HCD (e.g., an acknowledgement that the HCD 96 is exterior of the vehicle 12); and storing the value of the second threshold in the memory of the HCD 96. In one embodiment, the second threshold is a value associated with the weakest signal strength detectable by the HCD 96. Traversing the second threshold from LOW to HIGH (i.e., rising above the threshold) may indicate approaching the vicinity of the vehicle 12, whereas traversing the second threshold from HIGH to LOW (i.e., falling below the threshold) may indicate departing the vicinity of the vehicle 12.

Another VTE indicator may be detecting one or more sensor inputs associated with vehicle ingress or egress or that are otherwise indicative of the initiation or termination of a vehicle trip by the vehicle user carrying the HCD 96. As previously discussed, the BCM (one of multiple VSMs 42) of the vehicle 12 has a variety of sensors which may perform diagnostic, monitoring, control, reporting and/or other functions in real-time. Sensor inputs include values diagnosed, monitored, controlled, reported, detected, etc. These sensor inputs associated may include: the opening or the closing of the door of the vehicle 12; the increase or the decrease in the seat pressure of the vehicle 12 (e.g., the driver or passenger); the insertion or removal of the ignition key into or from the ignition lock of the vehicle 12; an engagement or disengagement of the engine of the vehicle 12 (e.g., by starting or turning off the engine using the ignition key); the engagement or disengagement of the transmission of the vehicle 12 (e.g., placing the vehicle 12 in PARK or in DRIVE or REVERSE); the depression of the brake pedal of the vehicle 12; the depression of the clutch pedal of the vehicle 12; the switching OFF of the exterior lighting of the vehicle 12 (e.g., the headlights, running lights, fog lights, etc.); the closing of one or more windows of the vehicle 12; the engagement or the disengagement of the seat buckle or passenger restraint of the vehicle 12; the opening or the closing of the gas cap of the vehicle 12; or the opening or the closing the fuel door of the vehicle 12 (i.e., the gas cap door).

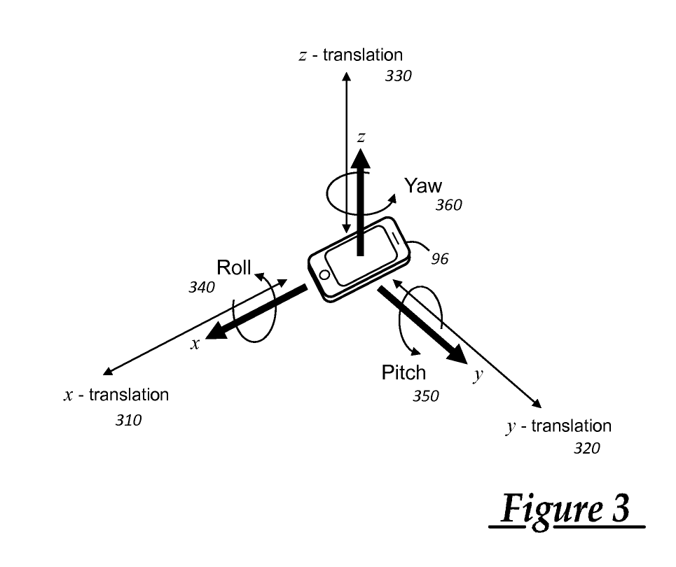

Another VTE indicator may be detecting at least one directional motion at the HCD 96 associated with the vehicle ingress or the vehicle egress of the vehicle user carrying the HCD 96. Directional motions of the HCD 96 may include (see FIG. 3) translation in the X, Y or Z directions (310, 320, 330); pitch, roll, or yaw (350, 340, 360); or any combination of directional motions, i.e., a directional motion sequence. Directional motion at the HCD 96 associated with vehicle ingress or vehicle egress may be detected by various approaches including: an accelerometer approach, a geo-magnetic approach, an optical approach, or a gyroscope approach. The accelerometer approach uses an accelerometer which is an instrument that may be coupled to (or embedded within) a device such as the HCD 96 which measures the acceleration of the device and may simultaneously measure accelerations in more than one coordinate axis (e.g., X, Y and/or Z). The geo-magnetics approach uses geo-magnetics which pertain to sensing the earth's magnetic field and detecting changes in orientation with respect to that magnetic field. Thus, for example, geo-magnetic hardware may be embedded within the HCD 96 to detect directional movement of the HCD 96 relative to the earth's magnetic field. The optical approach may use the camera of the HCD 96 to acquire a plurality of images and then use the hardware, software, and/or firmware of the HCD 96 to process the images thus detecting directional motion of the HCD 96 by detecting changes in the images. The gyroscope approach may be used for measuring or maintaining orientation based upon the principles of conservation of angular momentum. Today, integrated or circuit-based gyroscopes are commercially available (e.g., such as MicroElectroMechanical System or MEMS). MEMS may provide either analog or digital outputs and may comprise either or both an accelerometer and gyroscope. Under any approach, the detecting at least one directional motion at the HCD 96 associated with the vehicle ingress or the vehicle egress of the vehicle user carrying the HCD 96 may be ‘learned.’ An exemplary embodiment may include: the vehicle user initiating the learning process of the vehicle ingress of the HCD 96 by providing input to START or begin to a GUI or software program or application capable of storing a sequence of directional motions detected by the accelerometer, geo-magnetic hardware, camera and image processing, and/or gyroscope within the HCD 96; the vehicle user ingressing the vehicle 12 while carrying the HCD 96 while the HCD 96 records one or more directional motions; and the vehicle user terminating the learning process of the vehicle ingress of the HCD 96. These steps may be repeated to create an ingress profile of the vehicle user ingressing the vehicle 12. Additionally, an egress profile may be created. Also, the level of sensitivity (e.g., high, medium, or low) to the one or more directional motions of the HCD 96 may be preset by the manufacturer or controlled by the vehicle user; adjustments to sensitivity may be made at the HCD 96.

Another VTE indicator may be determining the detection of one VTE indicator within a selected amount of time before or after that of another VTE indicator. This selected amount of time may be measured using a clock pulse (e.g., in electronics and/or digital circuits, the clock pulse may be an electronic signal that oscillates between a HIGH and a LOW state and is utilized like a metronome to coordinate actions of circuits). Thus, in one implementation, the selected amount of time may comprise predetermined number of metronomic cycles. This selected amount of time may be a period of time stored in the memory of the HCD 96 which may be predetermined by human factors engineering or it may be ‘learned’ (e.g., during the creation of ingress or egress profiles). Where human factors engineering is used, the time that lapses betw VTn at least two VTE indicators may be estimated for the general population (i.e., for the 0^{th}-100^{th} percentile person) and that lapse of time may be characterized by the predetermined number of metronomic cycles or the selected amount of time. For example, the selected amount of time may begin upon the detection of one of the sensor inputs associated with the vehicle ingress or vehicle egress of the vehicle user carrying the HCD such as turning OFF the ignition key and end upon the detection of the traversal of the first threshold of the wireless signal strength. Human factors engineering may determine that the average amount of time that the general population requires for this sequence is 20 seconds and that if this sequence occurs within 20 seconds, it is a VTE indicator.

The aforementioned VTE indicators may be detected and/or processed at the HCD 96 or the vehicle telematics unit 30. Since the VTE indicators may be detected at either the HCD 96 or the vehicle 12, it is possible that some VTE indicators may need to be transmitted from either the HCD 96 to the vehicle telematics unit 30 or from the vehicle telematics unit 30 to the HCD 96 for evaluation. This transmission may occur wirelessly anytime following the establishment of the short-range wireless communication between the two devices.

Regardless of where the detection or processing may occur, the VTE indicators may then be evaluated. In one embodiment, the evaluation may be an implementation of IF-THEN statements (e.g., a series of and/or nested IF-THEN statements) such that ‘if’ the final evaluation is TRUE, ‘then’ the vehicle ingress or the vehicle egress is said to be determined. The implementation of such IF-THEN statements may occur in various ways; e.g., it may be implemented by a microprocessor or using one or more integrated circuits such as logic gates and may use one or more software programs, one or more firmware programs, hardware description language (HDL), or any other program related data. One exemplary embodiment may include the following: IF the wireless signal strength that traverses the first threshold is detected, and IF the traversal of the first threshold is from LOW to HIGH (i.e., rising above the threshold), and IF the sensor input associated with the vehicle ingress of the vehicle user carrying the HCD 96 is detected (e.g., the traversal of a threshold seat pressure from LOW to HIGH or rising above the threshold), and IF the detection of the traversal of the first threshold occurs within the selected amount of time of the detection of the sensor input of the vehicle 12; THEN make the evaluation and determination that the vehicle user carrying the HCD 96 has ingressed the vehicle 12. Another exemplary embodiment may include the following: IF the wireless signal strength that traverses the first threshold is detected, and IF the traversal of the first threshold is from HIGH to LOW (i.e., falling below the threshold), and IF the wireless signal strength that traverses the second threshold is detected, and IF the traversal of the second threshold is from HIGH to LOW (i.e., falling below the threshold), and IF the detection of the traversal of the first threshold occurs within a selected amount of time of the detection of the second threshold; THEN make the evaluation and determination that the vehicle user carrying the HCD 96 has egressed the vehicle 12. Another exemplary embodiment may include the following: IF the wireless signal strength that traverses the first threshold is detected, and IF the traversal of the first threshold is from HIGH to LOW (i.e., falling below the threshold), and IF at least one directional motion of the HCD 96 associated with the vehicle egress of the vehicle user is detected, and IF the detection of the traversal of the first threshold occurs within the selected amount of time of the detection of at least one directional motion of the HCD 96 associated with the vehicle egress of the vehicle user; THEN make the evaluation and determination that the vehicle user has egressed the vehicle 12.

In other embodiments of the determining step, multiple VTE indicators may be used and the selected amount of time may cover the period beginning with the first VTE indicator and ending with the last VTE indicator. For example, the detection of the first VTE indicator may begin the selected amount of time (e.g., at the first clock pulse). Then, the second and third VTE indicators may occur. And the fourth VTE indicator may end the period constituting the selected amount of time (e.g., at the last clock pulse). Thus, it may be determined whether the vehicle ingress or vehicle egress occurred based upon four VTE indicators. In one exemplary implementation: the first VTE indicator may detect the ignition of the vehicle 12 being disengaged (marking the beginning of the clock period); the second VTE indicator may detect the door of the vehicle 12 being opened; the third VTE indicator may detect the door of the vehicle 12 being closed; and the fourth VTE indicator may detect the traversal of the first threshold of the wireless signal strength from HIGH to LOW (i.e., falling below the threshold) (marking the end of the clock period). Provided the time lapsed from the first VTE indicator to the fourth VTE indicator (e.g., the total clock period) is less than or equal to the selected amount of time, then the determination of vehicle egress will be made.

It will be appreciated that where a clock pulse is used, the clock pulse may originate in the HCD 96 or the vehicle telematics unit 30. In addition, the use of IF-THEN is merely exemplary. The evaluation may use, e.g., IF-THEN-ELSE, FOR-NEXT, WHILE, etc. and may use any appropriate programming languages (FORTRAN, PASCAL, C++, etc.) whether ISO certified or not.

FIG. 2 also illustrates the step of providing a reminder message to the vehicle user via the HCD 96 when the vehicle trip initiation or termination is determined 220. The reminder message may be provided by visible, audible, and/or tactile indication or any combination thereof. A reminder message that is visible may be by display, a textual message, or a symbolic or picture message. A reminder message that is audible may be a specific tune or series of tunes and/or speech. For example, it may be a warning bell, a buzzer, or music (with or without words). A reminder message that is tactile may include one or more vibrations of the HCD 96. The nature of the reminder message may be dependent upon whether the vehicle trip was initiated or terminated (or whether the vehicle was ingressed or egressed). Reminder messages may include: a reminder to lock the doors of the vehicle 12; a reminder to secure the windows of the vehicle 12; a reminder to turn off a lighting of the vehicle 12 (such as interior, headlights, etc.); a reminder to recharge the power source of the vehicle 12; a reminder to renew a license plate of the vehicle 12; a reminder to set a self-reminder to feed a parking meter, or other self-reminders such as a grocery list, an appointment, or a trip list; or a reminder to perform vehicle service (vehicle services may include charging or recharging the battery; changing or filling fluids such as oil, coolant, transmission fluid, windshield washer, brake fluid, or tire pressure); changing an air filter; and any other particular service (e.g., service to the engine, transmission, brakes, etc.). Examples of reminder messages when the vehicle trip terminates may include messages to lock the doors, secure the windows, charge the power source (e.g., as in an electric car), and to set a reminder to feed a parking meter. Reminder messages may include a priority indicator representing the urgency of the reminder message and may be received simultaneously to the reminder message itself. The priority indicator may also include additional visible, audible, or tactile indications and may be configured by user. In one implementation, the priority indicator may be a cyclically repeated sequence such as three loud beeps followed by one brief pause wherein the additional audible indications are intended to notify the user of the higher importance of this reminder message. Thus for example if the vehicle user's license plates are within one week of expiration, the vehicle user may receive a textual reminder message stating RENEW LICENSE PLATES and priority indicator of three loud beeps followed by one brief pause (repeated).

In one embodiment, the providing step may be dependent upon whether the vehicle 12 and the HCD 96 are at a categorized geographic venue. Geographic venues may be categorized using WiFi Local Area Network (WLAN) and/or GPS. WiFi Local Area Network (WLAN) may identify the category of the geographic venue using the WLAN network name; e.g., Panera™, McDonalds™, Ruby Tuesday™, public libraries, etc. In addition, geographic venues may be identified and categorized using GPS technology (e.g., GPS coordinates and/or GPS satellite information). In one implementation, the reminder message may be provided based upon the categorized geographic venue. For example, in each instance where the vehicle is at the categorized geographic venue of the vehicle user's residence, the reminder message to charge the power source of the vehicle 12 may be provided when egress is determined. In another embodiment, the reminder message may not be provided because the vehicle is at the categorized geographic venue. For example, the reminder message to ‘lock your doors’ may not be provided when the vehicle user egresses the vehicle 12 to pump gas at a filling station. Geographic venue categories may be preset as a default within the vehicle telematics unit 30 or the HCD 96. However any default settings in the vehicle telematics unit 30 or the HCD 96 may be reprogrammed by the vehicle user. Types of locations where the reminder message may not be provided may include gas stations, convenience marts, fast food restaurants, service stations, residences, etc.

In another embodiment, the reminder message may not be provided to the vehicle user based upon the vehicle user's input to the HCD 96 after receiving the reminder message. For example, where the reminder message received at the filling station is to lock the doors of the vehicle 12, the vehicle user may elect to not receive such reminder messages in the future at any filling station or at this particular filling station by inputting this preference into the HCD 96 via the GUI or software program or application. This location (or type of location) may be stored in the memory of the HCD 96 and/or the digital memory devices 54 of the vehicle telematics units 30. When the vehicle egress or the vehicle egress criteria are once again met at that location (or type of location), no reminder message will be delivered.

The providing step also may include an option to display the reminder message again at a later time. The delay before the reminder message appears again may be selectable by vehicle user or may be preset and may be controlled by the vehicle telematics unit 30 or the HCD 96. The HCD 96 or the vehicle telematics unit 30 may comprise a timer which measures the length of the delay. Regardless of its location, when the timer expires, the vehicle telematics unit 30 or the HCD 96 may send the reminder message to the HCD 96. In one implementation where the reminder message may be displayed at a later time, the later message may be different than the original message. For example, if the original message displays LOCK VEHICLE DOORS, the later message may display REMINDER: LOCK VEHICLE DOORS.

FIG. 2 also shows an optional step 230 of transmitting an instruction from the HCD 96 to the vehicle telematics unit 30 comprising the execution of an auxiliary vehicle function. The HCD 96 may send the instruction to the vehicle telematics unit 30 via short-range wireless communication, and in turn the vehicle telematics unit 30 may communicate with the BCM which controls the execution of one or more auxiliary vehicle functions. The input of instructions into the HCD 96 may be accomplished by the use of the keypad of the HCD; the use of human voice spoken into the microphone of the HCD 96; the movement in one or more directional motions of the HCD 96; or any combinations thereof. Input of instructions via the keypad may include the use of a software program or application and may comprise selection from a menu of instructions and/or a password. The input of instructions by human voice may include voice recognition software in the HCD 96 or the vehicle telematics unit 30. The input of instructions by directional motion may include moving the HCD 96 in one or more directional motions (e.g., a command sequence) which may constitute a specific instruction or a code or password known by the vehicle user. Directional motions relative to the HCD 96 are shown in FIG. 3 and may include: a translation in the x-axis, a translation in the y-axis, a translation in the z-axis, a rotation or roll about the x-axis (which may include switching the HCD 96 from a face up to a face down position, or vice-versa; e.g., a 180-degree roll from a face up position to a 180-degree roll to a face down position), a rotation or pitch about the y-axis, or a rotation or yaw about the z-axis. In one embodiment, the instructions that are sent to BCM may be ignored where the instruction is received after a selected amount of time following the reminder message that was displayed by the HCD 96. When the selected amount of time expires prior to receiving the instruction, the instruction may be ignored by the HCD 96 by not sending the instruction to the vehicle telematics unit 30, or the vehicle telematics unit 30 receiving but disregarding the instruction. For example, the vehicle user may be within the vehicle 12; the HCD 96 and the vehicle telematics unit 30 may establish the short-range wireless communication; it may be determined that the vehicle user is leaving the vicinity of the vehicle 12 by one or more VTE indicators; the reminder message may be sent to the HCD 96 which states that the doors of the vehicle 12 are not locked; and the instruction commanding the doors of the vehicle 12 to lock may be sent from the HCD 96 by shaking the HCD 96 in the command sequence associated with locking the doors of the vehicle 12 within the selected amount of time.

The method or parts thereof can be implemented in a computer program product including instructions carried on a computer readable medium for use by one or more processors of one or more computers (e.g., within the HCD 96) to implement one or more of the method steps. The computer program product may include one or more software programs (or applications) comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program can be executed on one computer or on multiple computers in communication with one another.

The program(s) can be embodied on computer readable media, which can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of executing instructions corresponding to one or more steps of the disclosed method.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of providing a reminder message to a vehicle user, comprising the steps of:
(a) establishing a short-range wireless communication between a vehicle and a handheld communications device (HCD) carried by a vehicle user;
(b) determining a vehicle trip initiation or termination based on one or more detected vehicle trip endpoint indicators involving the user; and
(c) providing a reminder message to the vehicle user via the HCD in response to said determination.

2. The method of claim 1 wherein step (b) further comprises:
(b1) detecting a wireless signal strength that traverses a first threshold;
(b2) detecting a sensor input associated with the one or more vehicle trip endpoint indicators; and
(b3) determining the vehicle trip initiation or termination based on step (b1) occurring within a selected amount of time before or after step (b2).

3. The method of claim 2, wherein step (b1) further comprises detecting that the wireless signal strength falls below the first threshold and wherein step (b3) further comprises determining that a vehicle trip termination has occurred based on step (b2) occurring before step (b1).

4. The method of claim 2, wherein step (b1) further comprises detecting that the wireless signal strength rises above the first threshold and wherein step (b3) further comprises determining that a vehicle trip initiation has occurred based on step (b2) occurring after step (b1).

5. The method of claim 1 wherein step (b) further comprises:
(b1) detecting a wireless signal strength that traverses a first threshold;
(b2) detecting a wireless signal strength that traverses a second threshold which is less than the first threshold; and
(b3) determining the vehicle trip initiation or termination based on step (b1) occurring within a certain amount of time before or after step (b2).

6. The method of claim 5, wherein step (b1) further comprises detecting that the wireless signal strength falls below the first threshold, wherein step (b2) further comprises detecting that the wireless signal strength falls below the second threshold, and wherein step (b3) further comprises determining that a vehicle trip termination has occurred based on detecting that step (b1) has occurred before step (b2).

7. The method of claim 5, wherein step (b1) further comprises detecting that the wireless signal strength rises above the first threshold, wherein step (b2) further comprises detecting that the wireless signal strength rises above the second threshold and wherein step (b3) further comprises determining that a vehicle trip initiation has occurred based on detecting that step (b1) has occurred after step (b2).

8. The method of claim 1 wherein step (b) further comprises:
(b1) detecting a wireless signal strength that traverses a first threshold;
(b2) detecting at least one directional motion at the HCD associated with the vehicle trip initiation or termination; and
(b3) determining the vehicle trip initiation or termination based on step (b1) occurring within a selected amount of time of step (b2).

9. The method of claim 8, wherein step (b1) further comprises detecting that the wireless signal strength falls below the first threshold, wherein step (b2) further comprises a sequence of directional motions distinctive to the directional motions of the vehicle user during vehicle egress, and wherein step (b3) further comprises determining that the vehicle trip termination has occurred based on detecting that step (b1) has occurred after step (b2).

10. The method of claim 8, wherein step (b1) further comprises detecting that the wireless signal strength rises above the first threshold, wherein step (b2) further comprises a sequence of directional motions distinctive to the directional motions of the vehicle user during vehicle ingress, and wherein step (b3) further comprises determining that the vehicle trip initiation has occurred based on detecting that step (b1) has occurred before step (b2).

11. The method of claim 1 wherein the step (c) further comprises:
(c1) determining a location of the vehicle using global positioning satellites or a WiFi local area network (WLAN); and
(c2) providing the reminder message when the person is near a categorized geographic venue.

12. The method of claim 1 further comprising the step of transmitting an instruction from the HCD comprising the execution of an auxiliary vehicle function.

13. The method of claim 12 wherein the instruction comprises an input into the HCD of at least one directional motion.

14. The method of claim 1 wherein the reminder message is a reminder message to charge a power supply of the vehicle.

15. The method of claim 1 wherein the reminder message is a reminder message to lock the vehicle doors.

16. The method of claim 1 further comprising the step of selecting among a plurality of reminder messages wherein step (c) further comprises providing the selected reminder message to the vehicle user.

17. The method of claim 1 wherein the method further comprises the step of providing the vehicle user with additional reminder messages via the HCD.

18. A system of providing a reminder message to a vehicle user, comprising:
(a) a computer program product stored on a computer readable medium for a handheld communications device (HCD) having directional motion detection hardware, comprising one or more software programs that include program instructions that upon execution by the HCD cause it to recognize one or more directional motions associated with a vehicle ingress or a vehicle egress of a vehicle user carrying the HCD; and
(b) a vehicle telematics device (VTD) in short-range wireless communication with the HCD, wherein the vehicle user is provided a reminder message when the directional motion detection hardware and computer program product of the HCD detect one or more directional motions associated with the vehicle ingress or the vehicle egress of the vehicle user within a selected amount of time.

19. The system of claim 18 wherein the reminder message is provided by the HCD.

20. The system of claim 18 wherein the reminder message is provided by the VTD.
